(19) United States
(12) Patent Application Publication
(10) Pub. No.: US 2024/0294698 A1
(43) Pub. Date: Sep. 5, 2024

(54) POWDER COATING PRECURSOR CATALYST

(71) Applicant: Allnex Netherlands B.V., Bergen Op Zoom (NL)

(72) Inventors: Richard Hendrikus Gerrit BRINKHUIS, Zwolle (NL); Pengcheng YANG, Arnhem (NL)

(73) Assignee: Allnex Netherlands B.V., Bergen Op Zoom (NL)

(21) Appl. No.: 18/567,133

(22) PCT Filed: Jul. 5, 2022
(86) PCT No.: PCT/EP2022/068538

§ 371 Date: Dec. 5, 2023

(30) Foreign Application Priority Data
Jul. 5, 2021 (EP) 21183708.3

(51) Int. Cl. C08G 18/67; B05D 1/12; C08G 18/34; C08J 7/04; C09D 5/03

(52) U.S. Cl. CPC C08G 18/672; B05D 1/12; C08G 18/34; C08J 7/0427; C09D 5/03; B05D 2503/00; C08G 2150/20

(57) ABSTRACT

The invention is related to a powder coating composition comprising a crosslinkable composition and a catalyst system, wherein the crosslinkable composition is formed by a crosslinkable donor component A and a crosslinkable acceptor component B that are crosslinkable by a Real Michael Addition (RMA) reaction via the catalyst system, and which catalyst system is able to catalyze the RMA crosslinking reaction at a curing temperature below 140° C.; wherein the catalyst system comprises a (semi) crystalline precursor P, an activator C and optionally a retarder T.

### BACKGROUND OF THE INVENTION

The invention related to a powder coating composition comprising a crosslinkable composition that is crosslinkable via Real Michael Addition (RMA) and a catalyst system having a precursor P and an activator C and optionally a retarder T; a method for preparing the powder coating composition, a process for coating articles using said powder coating composition, the coated articles and the retarder T and precursor P for use in the catalyst system.

### DESCRIPTION OF THE RELATED ART

Powder coatings are dry, finely divided, free flowing, solid materials at room temperature and have gained popularity in recent years over liquid coatings. Powder coatings are generally cured at elevated temperatures between 120° C. and 200° C., more typically between 140° C. and 180° C. High temperatures are required to provide for sufficient flow of the binder to allow film formation and achieve good coating surface appearance, but also for achieving high reactivity for a crosslinking reaction. At low curing temperatures, one may face reaction kinetics that will not allow short cure times when demanding full mechanical and resistance property development; on the other hand, for systems where a high reactivity of the components may be created, the coatings likely have a poor appearance due to the relatively high viscosity of such systems at such lower temperatures, rapidly increasing further as the cure reaction proceeds: the time-integrated fluidity of such systems is too low to achieve sufficient leveling (see e.g. Progress in Organic Coatings, 72 page 26-33 (2011)). Especially when targeting thinner films, appearance may be limiting. Moreover, very high reactivities may lead to problems due to premature reaction when formulating powder paints in an extruder. In addition, highly reactive formulations may have a limited storage stability.

Patent application WO 2019/145472 describes a powder coating composition that provides a coating on substrates that are heat-sensitive substrates such as medium density fibre-board (MDF), wood, plastics and certain metal alloys and is able to cure at low temperature. This coating composition is curable via RMA using a catalyst system having only amorphous compounds.

However, the powder compositions described in the prior art provide coatings that have room for improvement with regard to flexibility, adhesion such as on metal and storage stability.

Therefore, there is still a need for a powder coating composition having good mechanical properties, can cure at low temperatures with a high curing speed and that provide excellent adhesion to substrates, such as metals, and provide a long term storage stability.

### BRIEF SUMMARY OF THE INVENTION

Present invention addresses one or more of the above problems by providing a powder coating composition as described in claim 1.

Accordingly a first aspect of the invention is related to a powder coating composition a crosslinkable composition and a catalyst system, wherein the crosslinkable composition is formed by a crosslinkable donor component A and a crosslinkable acceptor component B that are crosslinkable by a Real Michael Addition (RMA) reaction via the catalyst system, and which catalyst system is able to catalyze the RMA crosslinking reaction at a curing temperature below 140° C., 130 or even below 120° C., 110° C. or 100° C. and preferably at least 70° C., preferably at least 80, 90 or 100° C.,
wherein the crosslinkable composition comprises
a) the crosslinkable donor component A having at least 2 acidic C—H donor groups in activated methylene or methine, and
b) the crosslinkable acceptor component B having at least 2 activated unsaturated acceptor groups C═C, which react with component A by Real Michael Addition (RMA) to form a crosslinked network,
and
wherein the catalyst system comprises a (semi) crystalline precursor P; an activator C, and optionally retarder T;
wherein the a (semi) crystalline precursor P is a weak base with a pKa of its protonated form of more than 2, preferably more than 3, more preferably more than 4 and even more preferably at least 5 units lower than that of the activated C—H groups in donor component A; and the activator C can react with P at curing temperature, producing a strong base (CP) that can catalyze the Michael Addition reaction between A and B;
wherein the retarder T is preferably a (semi) crystalline retarder, wherein the retarder T is an acid that has a pKa of more than 2, more preferably more than 3, even more preferably more than 4 or 5 points lower than that of the activated C—H in A, and which upon deprotonation produces a weak base that can react with the activator C, producing a strong base that can catalyse the Michael Addition reaction between the crosslinkable compositions A and B.

In a second aspect, the invention is related to a (semi)crystalline catalyst retarder T or precursor P for use in a catalyst system for crosslinking a crosslinkable composition via a Real Michael Addition (RMA) reaction to obtain a powder coating composition according to any one of the claims 1-18, wherein the catalyst retarder T and/or precursor P is prepared by:
(ia) reacting HDI with a compound (i) which is a diol and a compound (ii) comprising a hydroxyl carboxylic acid groups to obtain a carboxylic acid based (semi) crystalline retarder T;
(ib) neutralizing the carboxylic acid based (semi) crystalline retarder T to obtain a (semi) crystalline precursor P; or
(iia) reacting HDI with a stoichiometric excess of compound (i) which is a diol to obtain a hydroxyl terminated urethane intermediate;
(iib) reacting the hydroxyl urethane intermediate with a cyclic anhydride to obtain a carboxylic acid based (semi) crystalline retarder T;
(iic) neutralizing the carboxylic acid based (semi) crystalline retarder T to obtain a (semi) crystalline precursor P; or
(iiia) reacting HDI with a compound (i) comprising a diol and a compound (iii) having a hydroxyl and carboxylate ester functional group to obtain a (semi) crystalline urethane ester;
(iiib) hydrolysing the ester groups of the (semi) crystalline urethane ester with a hydroxide to obtain a (semi) crystalline precursor P;
(iiic) optionally acidifying this (semi) crystalline precursor to obtain a crystalline retarder T;
(iva) reacting HDI with compound (i) comprising a diol and a compound (ii) comprising a hydroxyl and a tertiary amine functional group to obtain a tertiary amine based (semi) crystalline precursor P;
(ivb) protonating the tertiary-amine based (semi) crystalline precursor P to obtain a (semi) crystalline retarder T; or
(va) reacting HDI with compound (i) comprising a diol and a compound (ii) comprising a hydroxyl and an acrylate functional group to obtain an acrylate functional (semi) crystalline intermediate;
(vb) reacting the acrylate groups of the acrylate functional (semi) crystalline intermediate with a secondary amine to obtain a tertiary amine functional semi-crystalline precursor P;
(vc) protonating the tertiary-amine based (semi) crystalline precursor P to obtain a (semi) crystalline retarder T.

In a third aspect the invention is related to a method for powder-coating a substrate comprising
a. applying a layer comprising the powder coating composition according to embodiments of the first aspect, to a substrate surface wherein the substrate preferably is a temperature sensitive substrate, preferably MDF, wood, plastic, composite or temperature sensitive metal substrates like alloys and
b. heating to a curing temperature Tcur between 75 and 200° C., preferably between 80 and 180° C. and more preferably between 80 and 160, 150, 140, 130 or even 120° C., preferably using infrared heating, wherein the melt viscosity at the curing temperature Tour is preferably less than 60 Pas, more preferably less than 40, 30, 20, 10 or even 5 Pas;
c. and curing at Tour for a curing time preferably less than 40, 30, 20, 15, 10 or even 5 minutes.

In a fourth aspect the invention is related to articles coated with a powder comprising the powder coating composition according to embodiments of the first aspect, wherein the articles preferably have a temperature sensitive substrate preferably selected from the group of MDF, wood, plastic or metal alloys and wherein preferably the crosslinking density XLD is at least 0.01, preferably at least 0.02, 0.04, 0.07 or even 0.1 mmol/ml (as determined by DMTA) and is preferably lower than 3, 2, 1.5, 1 or even 0.7 mmol.

### DETAILED DESCRIPTION OF THE INVENTION

The inventors surprisingly found that a powder coating composition according to the invention whereby the precursor of the catalyst system is (semi) crystalline provides powder coating with very good adhesion properties, such as on metal substrates. In addition the powder coating provides a lower melting viscosity upon application during curing, which gives a better flow behavior and provides a coating with better appearances. The powder coating composition according to the invention also gives crystallization after extrusion which has a positive effect on the storage stability of the powder paints. Without being bound to a theory the plasticization effect (reduction of Tg) in the cured film contributes to improved mechanical properties like flexibility and adhesion on e.g. metals.

In the context of the present invention the term “(semi) crystalline compound” is a compound that has a melting temperature Tm above which the compound is liquid. In the context of the present invention, the “melting temperature” of the (semi) crystalline compound is the temperature at which the compound is completely melted when the compound is present in the composition comprising at least a crosslinkable system and a catalyst system as described in current invention, unless it is specified otherwise in the description below, as the melting temperature of the compound itself. The melting temperature reported herein are determined from Differential Scanning calorimetry (DSC) using a heating rate of 10° C./min.

### BRIEF DESCRIPTION OF THE FIGURES

FIG. 1. DSC temperature scan plots for PW2 between-30-210° C. at a rate of 10° C./min.

FIG. 2. DSC temperature scan plots for PW5 between-30-210° C. at a rate of 10° C./min.

### DESCRIPTION OF EMBODIMENTS

### The Catalyst System

In embodiments of the first aspect the catalyst system is able to crosslink the crosslinkable composition comprising a crosslinkable donor component A and a crosslinkable acceptor component B via Real Michael Addition (RMA), whereby the catalyst system comprises a (semi) crystalline precursor P and an activator C.

The precursor P is a weak base with a pKa of its protonated form of more than 2, preferably more than 3, more preferably more than 4 and even more preferably at least 5 units lower than that of the activated C—H groups in donor component A. The activator C can react with precursor P at curing temperature, producing a strong base (CP) that can catalyze the Michael Addition reaction between A and B.

The catalyst system may optionally further comprise retarder T, which is preferably (semi) crystalline, and which is an acid that has a pKa of more than 2, more preferably more than 3, even more preferably more than 4 or 5 points lower than that of the activated C—H in A, and which upon deprotonation produces a weak base that can react with the activator C, producing a strong base that can catalyse the Michael Addition reaction between the crosslinkable compositions A and B.

In one embodiment, the (semi) crystalline precursor and/or retarder is partially in a crystalline state and has a melting temperature below 140° C., preferably below 130° C., or 120° C., 110° or even below 100° C. such as between 80 and 10° C., preferably between 80 and 120° C.

In another embodiment, the (semi) crystalline precursor and/or retarder has a melting temperature of the compound itself, i.e. when not present in the coating composition, that is below 145° C., 130° C., preferably below 120° C., 110° or even below 100° C. such as between 80 and 130° C., preferably between 80 and 120° C. The melting temperature of the (semi) crystalline precursor and/or retarder itself can be slightly higher than the melting temperature when formulated in the paint and thus when present in the coating composition.

In another embodiment, the (semi) crystalline precursor P and the optionally (semi) crystalline retarder T comprise a urethane backbone. The urethane backbone is made by reacting an isocyanate, preferably a diisocyanate with at least a compound (i) having at least two isocyanate reactive groups such as an hydroxyl, and is preferably a diol.

It has surprisingly been found that when (semi) crystalline precursor and optionally retarder have a urethane backbone, and in particular a urethane backbone prepared from hexamethylene diisocyanate (HDI) with a selected diol and the targeted molecular weight provides a powder coating composition having a suitable melting temperature that recrystallizes after extrusion, has reduced melting viscosity compared to an amorphous precursor/retarder system and provides a coating with better adhesion and flexibility compared to an amorphous precursor/retarder system.

In a preferred embodiment the urethane backbone of the (semi) crystalline precursor and/or retarder is prepared by reacting hexamethylene diisocyanate (HDI) with a compound (i) comprising at least two, preferably two, isocyanate reactive groups, preferably an alcohol, more preferably a diol.

In another preferred embodiment the diol has a connecting chain between the hydroxyl groups that contain ether- or thioether groups (CH2-O—CH2, CH2-S—CH2, CH2-S—S—CH2) and the connection chain has a maximum length of 11 carbon atoms and/or heteroatoms between the hydroxyl groups; or
has a connecting chain between the hydroxyl groups containing a —CH(CH3)- unit or a —CH(CH2CH3)- preferably in a central position, whereby the connecting chain has a chain length that has an uneven number of carbon atoms and/or heteroatoms of less than 6 between the hydroxyl groups;
wherein the hydroxyl groups are primary hydroxyl groups and wherein the diols are not aromatic and not cycloaliphatic.

It has been found that such type of diols may provide a urethane backbone of the (semi) crystalline precursor/retarder that has the desired melting temperature and crystallisation tendency.

Preferably, compound (i) is a diol selected from the group consisting of diethylene glycol; triethylene glycol; 3-methyl 1,5-pentanediol, 2-methyl 1,3-propane diol; thio diethanol; 2, 2′-dithiodiethanol; tetraethylene glycol; di(1,3-propanediol); di(1,4-biutanediol).

In another embodiment, the (semi) crystalline retarder and/or precursor comprise a urethane backbone and is prepared by
(ia) reacting HDI with a compound (i) which is a diol and a compound (ii) comprising a hydroxyl carboxylic acid groups to obtain a carboxylic acid based (semi) crystalline retarder T;
(ib) neutralizing the carboxylic acid based (semi) crystalline retarder T to obtain a (semi) crystalline precursor P; or
(iia) reacting HDI with a compound (i) which is a diol to obtain a hydroxyl terminated urethane intermediate;
(iib) reacting the hydroxyl urethane intermediate with a cyclic anhydride to obtain a carboxylic acid based (semi) crystalline retarder T;
(iic) neutralizing the carboxylic acid based (semi) crystalline retarder T to obtain a (semi) crystalline precursor P; or
(iiia) reacting HDI with a compound (i) which is a diol and a compound (iii) having a hydroxyl carboxylate ester groups to obtain a (semi) crystalline urethane ester;
(iiib) hydrolysing the ester groups of the (semi) crystalline urethane ester with a hydroxide to obtain a (semi) crystalline precursor P;
(iiic) optionally acidifying the (semi) crystalline precursor of (iiib) to obtain a crystalline retarder T
(iva) reacting HDI with a diol component (i) and a compound (iv) comprising a hydroxyl and a tertiary amine functional group to obtain a tertiary amine based (semi) crystalline precursor P;
(ivb) protonating the tertiary-amine based (semi) crystalline precursor P to obtain a (semi) crystalline retarder T; or
(va) reacting HDI with a diol component (i) and a compound (v) comprising a hydroxyl and an acrylate functional group to obtain an acrylate functional (semi) crystalline intermediate;
(vb) reacting the acrylate groups of the acrylate functional (semi) crystalline intermediate with a secondary amine to obtain a tertiary amine functional semi-crystalline precursor P;
(vc) protonating the tertiary-amine based (semi) crystalline precursor P to obtain a (semi) crystalline retarder T.

The cyclic anhydride used in iib is preferably succinic anhydride or maleic anhydride,

Compound (ii) comprises both a hydroxyl as well as a carboxylic acid group and can e.g. be lactic acid, glycolic acid, hydroxypivalic acid, hydroxy butyric acid.

Compound (iii) comprises hydroxyl and carboxylate ester groups and can e.g. be ethyl lactate, or in general alkyl esters of the hydroxy acids described for compound (ii).

A person skilled in the art will understand that the hydrolyzed (semi) crystalline precursor P can be acidified to obtain a crystalline retarder T.

Compound (iv) comprising a hydroxyl and a tertiary amine functional group can be e.g. dimethyl ethanolamine;

In yet another embodiment, the (semi) crystalline precursor is prepared according to the above steps wherein the hydrolysis and/or neutralization is done with
hydroxide salt of a cation that is not acidic, preferably a cation according to formula Y(R′)4, wherein Y represents N or P, and wherein each R′ can be as same or different alkyl, aryl or aralkyl possible linked to a polymer, preferably a quaternary ammonium or phosphonium cation, preferably a tetra-butyl ammonium cation or tetra-ethyl ammonium cation; or
very strong basic amine, preferably selected from the group of amidines; preferably 1,8-diazabicyclo (5.4.0)undec-7-ene (DBU), or guanidines; preferably 1,1,3,3-tetramethylguanidine (TMG), optionally in the presence of some water.

In one embodiment, the number average molecular weight of the (semi) crystalline precursor is between 300 and 4000, preferably between 500 and 3000 g/mol, more preferably between 1000 and 2000 g/mol. Preferably an excess of isocyanate reactive groups over isocyanate groups is used. Accordingly, preferably, the ratio of the isocyanate reactive groups of compound (i) and if present compound (ii), (iii), (iv) or (v) in relative to the isocyanate groups is preferably above one. More preferably the molar ratio of the isocyanate reactive groups over isocyanate groups is between 1.0 to 1.5, more preferably from 1.01 to 1.2.

Also disclosed is a (semi) crystalline precursor P or retarder T whereby no compound (i) is used to prepare the urethane backbone.

In one embodiment the powder coating composition according to any one of the preceding claims, wherein the catalyst system is a separated catalyst system wherein the (semi) crystalline precursor P and activator C are macrophysically separated.

According to the invention, the term “macrophysically separated” means that reactable compounds P and C are essentially inaccessible for chemical reaction in the powder coating composition below curing temperature. This is because when preparing the powder coating composition, the semi(crystalline) precursor P and the acceptor C are no melt-mixed (also called extruded) together. This helps providing a powder coating composition with a longer storage time and provides a coating with matting appearances.

In one embodiment, the (semi) crystalline precursor P can be a salt formed by anion and a cation that is not acidic. Not acidic means not having a hydrogen that competes for base with crosslinkable donor component A, and thus not inhibiting the crosslinking reaction at the intended cure temperature. Preferably, the cation is substantially non-reactive towards any components in the crosslinkable composition. The cations can e.g. be alkali metals, quaternary ammonium or phosphonium but also protonated ‘superbases’ that are non-reactive towards any of the components A, B or C in the crosslinkable composition. Suitable superbases are known in the art.

In yet another embodiment, the catalyst system comprises
an activator C in an amount between 1 and 600 μeq/gr, preferably between 10 and 400, more preferably between 20 and 200 μeq/gr relative to total weight of binder components A and B and catalyst system,
a (semi) crystalline precursor P in an amount between 1 and 300 μeq/gr, preferably between 10 and 200, more preferably between 20 and 100 μeq/gr relative to total weight of binder components A and B and catalyst system,
optionally a retarder T in an amount between 1 and 500, preferably between 10 and 400, more preferably between 20 and 300 μeq/gr and most preferably between 30 and 200 μeq/gr, relative to total weight of binder components A and B and catalyst system
preferably wherein the equivalent amount of C
   (i) is higher than the amount of T, when present, preferably by an amount between 1 and 300 μeq/gr, preferably between 10 and 200, more preferably between 20 and 100 μeq/gr and
   (ii) is preferably higher than the amount of P and
   (iii) more preferably higher than the sum of the amount of P and T.

In yet another embodiment the catalyst system of the powder coating composition comprises a catalyst system
a. wherein the (semi) crystalline precursor represents between 10 and 100 equivalent % of the sum of P and T,
b. preferably the amount of retarder T is 20-400 eq %, preferably 30-300 eq % of the amount of P,
c. wherein preferably the ratio of the equivalent amount of C to the sum of the amount of P and T is at least 0.5, preferably at least 0.8, more preferably at least 1 and preferably at most 3, more preferably at most 2,
d. the ratio of C to T is preferably at least 1, preferably at least 1.5, most preferably at least 2.

In one embodiment, the catalyst system comprises the catalyst activator composition (C) comprising activator C1 that is preferably selected from the group of epoxide, carbodiimide, oxetane, oxazoline or aziridine functional components, preferably an epoxide or carbodiimide.

A most preferred catalyst activator C1 contains an epoxy group. Suitable choices for the epoxide as preferred activator C1 are cycloaliphatic epoxides, epoxidized oils and glycidyl type epoxides. Suitable components C1 are described e.g. in U.S. Pat. No. 4,749,728 Col 3 Line 21 to 56 and include C10-18 alkylene oxides and oligomers and/or polymers having epoxide functionality including multiple epoxy functionality. Particularly suitable mono-epoxides include, tert-butyl glycidyl ether, phenyl glycidyl ether, glycidyl acetate, glycidyl esters of versatic esters, glycidyl methacrylate (GMA) and glycidyl benzoate. Useful multifunctional epoxides include bisphenol A diglycidyl ether, as well as higher homologues of such BPA epoxy resins, glycidyl ethers of hydrogenated BPA, such as Eponex 1510 (Hexion), ST-4000D (Kukdo), aliphatic oxirane such as epoxidised soybean oil, diglycidyl adipate, 1,4-diglycidyl butyl ether, glycidyl ethers of Novolac resins, glycidyl esters of diacids such as Araldite PT910 and PT912 (Huntsman), TGIC and other commercial epoxy resins. Bisphenol A diglycidyl ether, as well as its solid higher molecular weight homologues are preferred epoxides. Also useful are acrylic (co)polymers having epoxide functionality derived from glycidyl methacrylate. In a preferred embodiment, the epoxy components are oligomeric or polymeric components with an Mn of at least 400 (750, 1000, 1500). Other epoxide compounds include 2-methyl-1,2-hexene oxide, 2-phenyl-1,2-propene oxide (alpha-methyl styrene oxide), 2-phenoxy methyl-1,2-propene oxide, epoxidized unsaturated oils or fatty esters, and 1-phenyl propene oxide. Useful and preferred epoxides are glycidyl esters of a carboxylic acid, which can be on a carboxylic acid functional polymer or preferably on a highly branched hydrophobic carboxylic acid like Cardura E10P (glycidyl ester of Versatic™ Acid 10). Most preferred are typical powder crosslinker epoxy components: triglycidyl isocyanurate (TGIC), Araldite PT910 and PT912, and phenolic glycidyl ethers that are solid in nature at ambient temperature, or acrylic (co)polymers of glycidyl methacrylate.

Optionally, in some preferred embodiments, the catalyst system further comprises a retarder T, which is an acid that has a pKa of 2, preferably 3, more preferably 4 and most preferably 5 points lower than that of the activated C—H in the crosslinkable donor component A, and which upon deprotonation produces a weak base that can act as a P1 precursor, and can react with the activator C1, to produce a strong base that can catalyze the Michael Addition reaction between A and B. The retarder T is preferably a protonated precursor P1. The retarder T can be part of the catalyst precursor composition or of the catalyst activator composition. It can also be part of both the catalyst precursor composition and the catalyst activator composition. Preferably the retarder T and the protonated precursor P1 have a boiling point of at least 120° C., preferably 130° C., 150, 175, 200 or even 250° C. Preferably, retarder T is a carboxylic acid. The use of a retarder T can have beneficial effects in postponing the crosslinking reaction to allow more interdiffusion of the components during cure, before mobility limitations become significant.

The retarder is most preferably (semi) crystalline as described above.

The pKa values referred to in this patent application, are aqueous pKa values at ambient conditions (21° C.). They can be readily found in literature and if needed, determined in aqueous solution by procedures known to those skilled in the art.

To be able to provide a helpful delay of the crosslinking reaction under cure conditions, the reaction of the retarder T and its deprotonated version P1 with activator C1 should take place with a suitable rate. A preferred catalyst system comprises as catalyst activator C1 an epoxy, as catalyst precursor P1 a weak base nucleophilic anion group that reacts with the epoxide group of C1 to form a strongly basic adduct C1, and most preferably also a retarder T. In a suitable catalyst system, P1 is a carboxylate salt and C1 is epoxide, carbodiimide, oxetane or oxazoline, more preferably an epoxide or carbodiimide, and T is a carboxylic acid. Alternatively P1 is a tertiary amine C1 is an epoxy, and T is a carboxylic acid.

Without wishing to be bound to a theory it is believed that the nucleophilic anion P1 reacts with the activator epoxide C1 to give a strong base, but that this strong base is immediately protonated by the retarder T to create a salt (similar in function to P1) that will not directly strongly catalyse the crosslinking reaction. The reaction scheme takes place until substantially complete depletion of the retarder T, which provides for the open time because no significant amount of strong base is present during that time to significantly catalyse the reaction of the crosslinkable components A and B. When the retarder T is depleted, a strong base will be formed and survive to effectively catalyse the rapid RMA crosslinking reaction.

The features and advantages of the invention will be appreciated upon reference to the following exemplary reaction scheme.

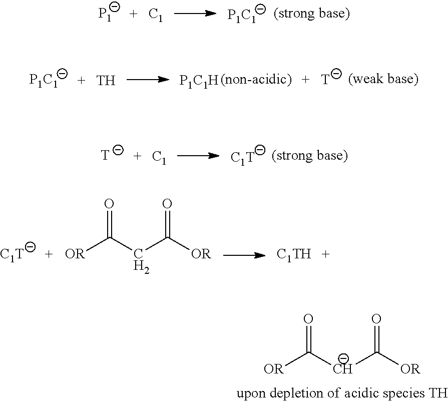

Specifically for the case of carboxylates, epoxides and carboxylic acids as P1, C1 and T species, this can be drawn up as:**replaced the picture**

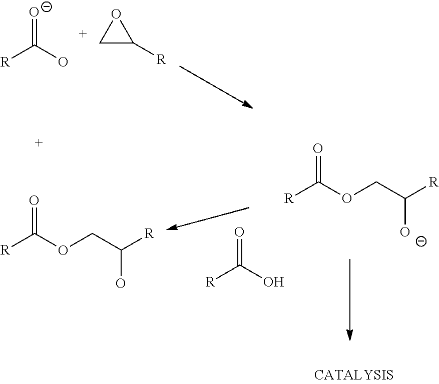

In some cases, the detailed mechanism of the reaction of the activator C1 with the precursor P1 may not be known, or subject of debate, and a reaction mechanism involving the protonated form of P1 actually involved in the reaction may be suggested. The net effect of such a reaction sequence might be similar to the sequence described based on its progress though the deprotonated form of P1. Systems where reaction might be argued to proceed along the protonated P1 pathway, are included in this invention. In this case, after depletion of the retarder T, C1 would react with a protonated P1 created from the acid-base equilibrium with Michael donor species A, and its reaction would activate crosslinking due to this acid-base equilibrium being drawn to the deprotonated Michael donor side.

The reaction scheme, if the activator would react through the protonated form of P1H would be illustrated by the next scheme:

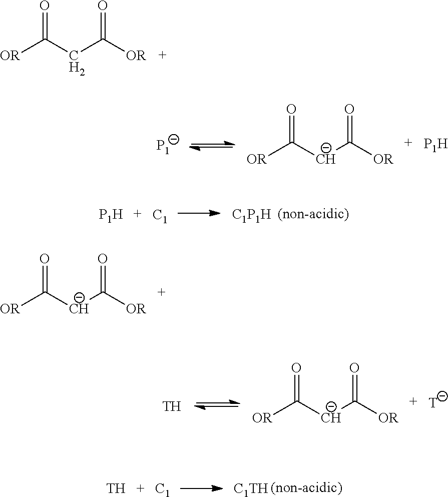

In one embodiment retarder T is a protonated anion group P1, preferably carboxylic acid T and carboxylate P1, which for example can be formed by partially neutralising an acid functional component, preferably a polymer comprising acid groups as retarder T to partially convert to anionic groups on P1, wherein the partial neutralizing is done preferably by a cation hydroxide or (bi)carbonate, preferably tetraalkylammonium or tetraalkylphosphonium cations. In another embodiment, a polymer bound component P1 can be made by hydrolysis of an ester group in a polyester with aforementioned hydroxides.

### Crosslinkable Components

The powder coating composition further comprises the crosslinkable composition comprising
a) the crosslinkable donor component A having at least 2 acidic C—H donor groups in activated methylene or methine, and
b) the crosslinkable acceptor component B having at least 2 activated unsaturated acceptor groups C═C, which react with component A by Real Michael Addition (RMA) to form a crosslinked network,

In one specific embodiment the crosslinkable donor component A and/or the crosslinkable acceptor B are (semi) crystalline compounds, preferably having a urethane backbone, which urethane backbone is preferably prepared by reacting a hexamethylene diisocyanate with a compound comprising at least two isocyanate reactive groups, preferably an alcohol, more preferably a diol.

Preferably, the diol has:
a connecting chain between the hydroxyl groups that contain ether- or thioether groups, preferably —CH2-O—CH2-, —CH2-S—CH2-, —CH2-S—S—CH2- and the connection chain has a maximum length of 11 carbon atoms and/or heteroatoms between the hydroxyl groups; or
a connecting chain between the hydroxyl groups containing a —CH(CH3)- unit or a —CH(CH2CH3)- preferably in a central position, whereby the connecting chain has a chain length that has an uneven number of carbon atoms and/or heteroatoms of less than 6 between the hydroxyl groups;
wherein the hydroxyl groups are primary hydroxyl groups and wherein the diols are not aromatic and not cycloaliphatic.

The diol is preferably selected from the group consisting of diethylene glycol; triethylene glycol; 3-methyl 1,5-pentanediol, 2-methyl 1,3-propane diol; thio diethanol; dithio diethanol; tetraethylene glycol; di(1,3-propanediol) di(1,4-butanediol).

Without being bound to a theory, it is assumed that when the backbone of the donor component A and/or the crosslinkable acceptor B is similar or the same as that from the crystalline precursor B, a better (co)crystallisation is achieved, even at low concentration.

Therefor in another preferred embodiment the urethane backbone of the (semi) crystalline donor component A and/or the (semi) crystalline acceptor B and the (semi) crystalline precursor (P) have a urethane backbone prepared by the same components, preferably wherein the urethane backbone is prepared by reacting HDI with the same compound (i) having at least two isocyanate reactive groups, preferably a diol as described above.

In this embodiment, preferably, at least the crosslinkable donor component A and/or a at least a crosslinkable acceptor component B are (semi) crystalline and comprise a polyurethane backbone formed by:
reacting a polyisocyanate, which is substantially hexamethylene diisocyanate (HDI), with a compound (i) comprising at least two, preferably two, isocyanate reactive groups, preferably hydroxyls, more preferably is a diol; and
a compound (iia) comprising at least one, preferably 1, isocyanate reactive groups, preferably a hydroxyl and at least one functional group having at least one acidic C—H donor groups in activated methylene or methine, to form a (semi) crystalline donor component A; or
a compound (iib) comprising at least one, preferably 1, isocyanate reactive groups, preferably a hydroxyl and at least one functional group having at least one activated unsaturated acceptor groups C═C, to form the (semi) crystalline acceptor component B.

According to this invention, with “substantially” it is meant that at least 95% of the polyisocyanates that are used is HDI.

In one embodiment the crosslinkable component A comprises at least 2 acidic C—H donor groups in activated methylene or methine in a structure Z1(—C(—H)(—R)—)Z2 wherein R is hydrogen, a hydrocarbon, an oligomer or a polymer, and wherein Z1 and Z2 are the same or different electron-withdrawing groups, preferably chosen from keto, ester or cyano or aryl groups, and preferably comprises an activated C—H derivative having a structure according to formula 1:

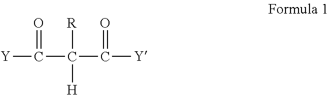

wherein R is hydrogen or an optionally substituted alkyl or aryl and Y and Y′ are identical or different substituent groups, preferably alkyl, aralkyl or aryl, or alkoxy or wherein in formula 1 the —C(═O)—Y and/or —C(═O)—Y′ is replaced by CN or aryl, no more than one aryl or wherein Y or Y′ can be NRR′ (R and R′ are H or optionally substituted alkyl) but preferably not both, wherein R, Y or Y′ optionally provide connection to an oligomer or polymer, said component A preferably being a malonate, acetoacetate, malonamide, acetoacetamide or cyanoacetate groups, preferably providing at least 50, preferably 60, 70 or even 80% of the total of C—H acidic groups in crosslinkable component A,
b. Component B comprises the at least 2 activated unsaturated RMA acceptor groups preferably originate from acryloyl, methacryloyl, itaconates, maleate or fumarate functional groups,
wherein preferably at least one, more preferably both, of components A or B is a polymer and
wherein preferably the composition comprises a total amount donor groups C—H and acceptor groups C═C per gram binder solids from 0.05 to 6 meq/gr binder solids and preferably the ratio of acceptor groups C═C to donor groups C—H is more than 0.1 and less than 10.

Preferably at least one, more preferably both, of components A or B is a polymer

Preferably, the crosslinkable composition comprises a total amount donor groups C—H and acceptor groups C═C per gram binder solids from 0.05 to 6 meq/gr binder solids and preferably the ratio of acceptor groups C═C to donor groups C—H is more than 0.1 and less than 10.

Real Michael Addition (RMA) crosslinkable coating compositions comprising crosslinkable components A and B are generally described for use in solvent borne systems in EP2556108, EP0808860 or EP1593727 which specific description for crosslinkable components A and B are herewith considered to be enclosed.

The components A and B respectively comprise the RMA reactive donor and acceptor moieties which on curing react to form the crosslinked network in the coating. The components A and B can be present on separate molecules but can also be present on one molecule, referred to as a hybrid A/B component, or combinations thereof.

Preferably, components A and B are separate molecules and each independently in the form of polymers, oligomers, dimers or monomers. For coating applications, it is preferred at least one of component A or B preferably are oligomers or polymers. It is noted that an activated methylene group CH2 comprises 2 C—H acidic groups. Even though, after reaction of the first C—H acidic group, the reaction of the second C—H acid group is more difficult, e.g. for reaction with methacrylates, as compared to acrylates, the functionality of such activated methylene group is counted as 2. The reactive components A and B can also be combined in one A/B hybrid molecule. In this embodiment of the powder coating composition both C—H and C═C reactive groups are present in one A-B molecule.

Preferably, component A is a polymer, preferably a polyester, polyurethane, acrylic, epoxy or polycarbonate, having as a functional group a component A and optionally one or more components B, or components from catalytic system C. Also, mixtures or hybrids of these polymer types are possible. Suitably component A is a polymer chosen from the group of acrylic, polyester, polyester amide, polyester-urethane polymers.

Malonates or acetoacetates are preferred donor types in component A. In view of high reactivity and durability in a most preferred embodiment of the crosslinkable composition, component A is a malonate C—H containing compound. It is preferred that in the powder coating composition the majority of the activated C—H groups are from malonate, that is more than 50%, preferably more than 60%, more preferably more than 70%, most preferably more than 80% of all activated C—H groups in the powder coating composition are from malonate.

Preferred are oligomeric and/or polymeric malonate group-containing components such as, for example, polyesters, polyurethanes, polyacrylates, epoxy resins, polyamides and polyvinyl resins or hybrids thereof containing malonate type groups in the main chain, pendant or both.

The total amount of donor groups C—H and acceptor groups C═C per gram binder solids, independent of how they are distributed over the various crosslinkable components, is preferably between 0.05 to 6 meq/gr, more typically 0.10 to 4 meq/gr, even more preferably 0.25 to 3 meq/gr binder solids, most preferably between 0.5 to 2 meq/gr. Preferably, the stoichiometry between components A and B is chosen such that the ratio of reactive C═C groups to reactive C—H groups is more than 0.1, preferably more than 0.2, more preferably more than 0.3, most preferably more than 0.4, and, in the case of acrylate functional groups B preferably more than 0.5 and most preferably more than 0.75, and the ratio is preferably less than 10, preferably 5, more preferably less than 3, 2 or 1.5.

The malonate group-containing polyesters can be obtained preferably by the transesterification of a methyl or ethyl diester of malonic acid, with multifunctional alcohols that can be of a polymeric or oligomeric nature but can also be incorporated through a Michael Addition reaction with other components. Especially preferred malonate group-containing components for use with the present invention are the malonate group-containing oligomeric or polymeric esters, ethers, urethanes and epoxy esters and hybrids thereof, for example polyester-urethanes, containing 1-50, more preferably 2-10, malonate groups per molecule. Polymer components A can also be made in known manners, for example by radical polymerisation of ethylenically unsaturated monomers comprising monomers, for example (meth)acrylate, functionalised with a moiety comprising activated C—H acid (donor) groups, preferably an acetoacetate or malonate group, in particular 2-(methacryloyloxy)ethyl acetoacetate or -malonate. In practice polyesters, polyamides and polyurethanes (and hybrids of these) are preferred. It is also preferred that such malonate group containing components have a number average molecular weight (Mn) in the range of from about 100 to about 10000, preferably 500-5000, most preferably 1000-4000; and a Mw less than 20000, preferably less than 10000, most preferably less than 6000 (expressed in GPC polystyrene equivalents).

Suitable crosslinkable components B generally can be ethylenically unsaturated components in which the carbon-carbon double bond is activated by an electron-withdrawing group, e.g. a carbonyl group in the alpha-position. Representative examples of such components are disclosed in U.S. Pat. No. 2,759,913 (column 6, line 35 through column 7, line 45), DE-PS-835809 (column 3, lines 16-41), U.S. Pat. No. 4,871,822 (column 2, line 14 through column 4, line 14), U.S. Pat. No. 4,602,061 (column 3, line 14 20 through column 4, line 14), U.S. Pat. No. 4,408,018 (column 2, lines 19-68) and U.S. Pat. No. 4,217,396 (column 1, line 60 through column 2, line 64).

Acrylates, methacrylates, itaconates, fumarates and maleates are preferred. Itaconates, fumarates and maleates can be incorporated in the backbone of a polyester or polyester-urethane. Preferred example resins such as polyesters, polycarbonates, polyurethanes, polyamides, acrylics and epoxy resins (or hybrids thereof) polyethers and/or alkyd resins containing activated unsaturated groups may be mentioned. These include, for example, urethane (meth)acrylates obtained by reaction of a polyisocyanate with an hydroxyl group containing (meth)acrylic ester, e.g., an hydroxy-alkyl ester of (meth)acrylic acid or a component prepared by esterification of a poly-hydroxyl component with less than a stoichiometric amount of (meth)acrylic acid; polyether (meth)acrylates obtained by esterification of an hydroxyl group-containing polyether with (meth)acrylic acid; poly-functional (meth)acrylates obtained by reaction of an hydroxy-alkyl (meth)acrylate with a poly-carboxylic acid and/or a poly-amino resin; poly(meth)acrylates obtained by reaction of (meth)acrylic acid with an epoxy resin, and poly-alkyl maleates obtained by reaction of a mono-alkyl maleate ester with an epoxy resin and/or an hydroxy functional oligomer or polymer. Also, polyesters end-capped with glycidyl methacrylate are a preferred example. It is possible that the acceptor component contains multiple types of acceptor functional groups.

Most preferred activated unsaturated group-containing components B are the unsaturated acryloyl, methacryloyl and fumarate functional components. Preferably the number average functionality of activated C═C groups per molecule is 2-20, more preferably 2-10, most preferably 3-6. The equivalent weight (EQW: average molecular weight per reactive functional group) is 100-5000, more preferable 200-2000, and the number average molecular weight preferably is Mn 200-10000, more preferable 300-5000, most preferably 400-3500 g/mole, even more preferably 1000-3000 g/mole.

In view of the use in powder systems the Tg of component B is preferably above 25, 30, 35, more preferably at least 40, 45, most preferably at least 50° C. or even at least 60° C., because of the need for powder stability. The Tg is defined as measured with DSC, mid-point, heating rate 10° C./min. If one of the components has a Tg substantially higher than 50° C., the Tg of the other formulation components can be lower as will be understood by those skilled in the art.

A suitable component B is a urethane (meth)acrylate which has been prepared by reacting a hydroxy- and (meth)acrylate functional compound with isocyanate to form urethane bonds, wherein the isocyanates are preferably at least in part di- or tri-isocyanates, preferably isophorone diisocyanate (IPDI). The urethane bonds introduce stiffness on their own but preferably high Tg isocyanates are used like cyclo-aliphatic or aromatic isocyanates, preferably cycloaliphatic. The amount of such isocyanates used is preferably chosen such that said (meth)acrylate functional polymer Tg is raised above 40, preferably above 45 or 50° C.

The powder coating composition is designed preferably in such a way, that after cure, a crosslink density (using DMTA) can be determined of at least 0.025 mmole/cc, more preferably at least 0.05 mmole/cc, most preferably at least 0.08 mmole/cc. and typically less than 3, 2, 1 or 0.7 mmole/cc.

The powder coating composition should retain free flowing powder at ambient conditions and therefore preferably has a Tg above 25° C., preferably above 30° C., more preferably above 35, 40, 50° C. as the midpoint value determined by DSC at a heating rate of 10° C./min.

As described above the preferred component A is a malonate functional component. However, incorporation of malonate moieties tends to reduce the Tg and it has been a challenge to provide powder coating composition based on malonate as the dominant component A with sufficiently high Tg.

In view of achieving high Tg, the powder coating composition preferably comprises a crosslinkable composition of which crosslinkable donor component A and/or the crosslinkable acceptor component B, which may be in the form of a hybrid component A/B, comprises amide, urea or urethane bonds and/or whereby the crosslinkable composition comprises high Tg monomers, preferably cycloaliphatic or aromatic monomers or in case of polyesters, one or more monomers chosen from the group of 1,4-dimethylol cyclohexane (CHDM), tricyclodecanedimethanol (TCD diol), isosorbide, penta-spiroglycol, hydrogenated bisphenol A and tetra-methyl-cyclobutanediol.

Further, in view of achieving high Tg, the powder coating composition comprises component B or hybrid component A/B being a polyester (meth-)acrylate, a polyester urethane (meth-)acrylate, an epoxy (meth-)acrylate or a urethane (meth-)acrylate, or is a polyester comprising fumarate, maleate or itaconate units, preferably fumarate or is a polyester end-capped with isocyanate or epoxy functional activated unsaturated group.

Most preferably the powder coating composition comprises an RMA crosslinkable composition, which has features adapted for use in an RMA crosslinkable powder coating composition. In particular in view of achieving good flow and levelling properties, and good chemical and mechanical resistances, it was found that preferably in the powder coating composition at least one of crosslinkable components A or B or hybrid A/B is a polymer, preferably chosen from the group of acrylic, polyester, polyester amide, polyester-urethane polymers, which polymer
has a number average molecular weight Mn, as determined with GPC, of at least 450 gr/mole, preferably at least 1000, more preferably at least 1500 and most preferably at least 2000 gr/mole;
has a weight average molecular weight Mw, as determined with GPC, of at most 20000 gr/mole, preferably at most 15000, more preferably at most 10000 and most preferably at most 7500 gr/mole;
preferably has a polydispersity Mw/Mn below 4, more preferably below 3;
has an equivalent weight EQW in C—H or C═C of at least 150, 250, 350, 450 or 550 gr/mole and preferably at most 2500, 2000, 1500, 1250 or 1000 gr/mole and a number average functionality of reactive groups C—H or C═C between 1-25, more preferably 1.5-15 even more preferably 2-15, most preferably 2.5-10 C—H groups per molecule;
preferably has a melt viscosity at a temperature in the range between 100 and 140° C. less than 60 Pas, more preferably less than 40, 30, 20, 10 or even 5 Pas;
preferably comprises amide, urea or urethane bonds and/or comprises high Tg monomers, preferably cycloaliphatic or aromatic monomers, in particular polyester monomers chosen from the group of 1,4-dimethylol cyclohexane (CHDM), tricyclodecanedimethanol (TCD diol), isosorbide, penta-spiroglycol or hydrogenated bisphenol A and tetramethyl-cyclobutanediol; and/or
has a Tg above 25° C., preferably above 35° C., more preferably above 40, 50 or even 60° C. as as the midpoint value determined by DSC at a heating rate of 10° C./min or is a crystalline polymer with a melting temperature between 40° C. and 150, preferably 130° C., preferably at least 50 or even 70° C. and preferably lower than 120° C. (as determined by DSC at a heating rate of 10° C./min).

The polymer features Mn, Mw and Mw/Mn are chosen in view of on one hand the desired powder stability and on the other hand the desired low melt viscosity, but also the envisaged coating properties. A high Mn is preferred to minimize Tg reduction effects of end groups, on the other hand low Mw's are preferred because melt viscosity is very much related to Mw and a low viscosity is desired; therefore low Mw/Mn is preferred.

In view of achieving high Tg the RMA crosslinkable polymer preferably comprises amide, urea or urethane bonds and/or comprising high Tg monomers, preferably cycloaliphatic or aromatic monomers, or in case of polyesters comprises monomers chosen from the group of 1,4-dimethylol cyclohexane (CHDM), TCD diol, isosorbide, penta-spiroglycol or hydrogenated bisphenol A and tetramethyl-cyclobutanediol.

In case the RMA crosslinkable polymer is an A/B hybrid polymer it is further preferred that the polymer also comprises one or more component B groups chosen from the group of acrylate or methacrylate, fumarate, maleate and itaconate, preferably (meth)acrylate or fumarate. Further, if to be used as crystalline material, it is preferred that the RMA crosslinkable polymer has crystallinity with a melting temperature between 40° C. and 130° C., preferably at least 50 or even 70° C. and preferably lower than 150, 130 or even 120° C. (as determined by DSC at a heating rate of 10° C./min) It is noted that this is the melting temperature of the (pure) polymer itself and not of the polymer in the composition.

In a preferred embodiment the RMA crosslinkable polymer comprising polyester, polyester amide, polyester-urethane or a urethane-acrylate which comprises urea, urethane or amide bonds derived from cycloaliphatic or aromatic isocyanates, preferably cycloaliphatic isocyanates, said polymer having a Tg of at least 40° C., preferably at least 45 or 50° C. and at most 120° C. and a number average molecular weight Mn of 450-10000, preferably 1000-3500 gr/mole and preferably a maximum Mw of 20000, 10000 or 6000 gr/mole and which polymer is provided with RMA crosslinkable components A or B or both. The polymer is obtainable for example by reacting a precursor polymer comprising said RMA crosslinkable groups with an amount of cycloaliphatic or aromatic isocyanates to increase the Tg. The amount of such isocyanates added, or urea/urethane bonds formed, is chosen such the Tg is raised to at least 40° C., preferably at least 45 or 50° C.

Preferably, the RMA crosslinkable polymer is a polyester or polyester-urethane comprising a malonate as the dominant component A and comprising a number average malonate functionality of between 1-25, more preferably 1.5-15 even more preferably 2-15, most preferably 2.5-10 malonate groups per molecule, has a GPC weight average molecular weight between 500 and 20000, preferably 1000-10000, most preferably 2000-6000 gr/mole, which has been prepared by reacting a hydroxy- and malonate functional polymer with isocyanate to form urethane bonds.

Further, the polymer can be an amorphous or (semi-)crystalline polymer or a mixture thereof. Semi-crystalline means being partly crystalline and partly amorphous. (Semi)-crystallinity is to be defined by DSC melting endotherms, targeted crystallinity defined as having a DSC peak melting temperature Tm at least 40° C., preferably at least 50° C., more preferably at least 60° C. and preferably at most 130, 120, 110 or 100° C. The DSC Tg of such a component in fully amorphous state preferably is below 40° C., more preferably below 30, 20 or even 10° C.

### (Semi) Crystalline Retarder and Precursor

In a second aspect, the invention is related to a (semi)crystalline catalyst retarder T or precursor P for use in a catalyst system for crosslinking a crosslinkable composition via a Real Michael Addition (RMA) reaction to obtain the powder coating composition according to any one of the claims 1-18, wherein the catalyst retarder T precursor is prepared by:
(ia) reacting HDI with a compound (i) which is a diol and a compound (ii) comprising a hydroxyl and a carboxylic acid group to obtain a carboxylic acid based (semi) crystalline retarder T;
(ib) neutralizing the carboxylic acid based (semi) crystalline retarder T to obtain a (semi) crystalline precursor P; or
(iia) reacting HDI with an excess of compound (i) which is a diol to obtain a hydroxyl terminated urethane intermediate;
(iib) reacting the hydroxyl urethane intermediate with a cyclic anhydride to obtain a carboxylic acid based (semi) crystalline retarder T;
(iic) neutralizing the carboxylic acid based (semi) crystalline retarder T to obtain a (semi) crystalline precursor P; or
(iiia) reacting HDI with a compound (i) comprising a diol and a compound (iii) having a hydroxyl and a carboxylate ester group to obtain a (semi) crystalline urethane ester;
(iiib) hydrolysing the ester groups of the (semi) crystalline urethane ester with a hydroxide to obtain a(semi) crystalline precursor P;
(iiic) optionally acidifying this (semi) crystalline precursor to obtain a crystalline retarder T; (iva) reacting HDI with a diol component (i) and a compound (ii) comprising a hydroxyl and a tertiary amine functional group to obtain a tertiary amine based (semi) crystalline precursor P;
(ivb) protonating the tertiary-amine based (semi) crystalline precursor P to obtain a (semi) crystalline retarder T; or
(va) reacting HDI with a diol component (i) and a compound (ii) comprising a hydroxyl and an acrylate functional group to obtain an acrylate functional (semi) crystalline intermediate;
(vb) reacting the acrylate groups of the acrylate functional (semi) crystalline intermediate with a secondary amine to obtain a tertiary amine functional semi-crystalline precursor P;
(vc) protonating the tertiary-amine based (semi) crystalline precursor P to obtain a (semi) crystalline retarder T.

The embodiments and preferred examples as described for the (semi) crystalline precursor and retarder in the first aspect of the invention also apply for the second aspect of the invention.

### Substrate and Coating

The invention also relates to a method for powder-coating a substrate comprising
a. Providing the powder coating composition according to the invention,
b. Applying a layer of the powder to a substrate surface and
c. Heating to a curing temperature Tour between 75 and 140° C., preferably between 80 and 130, 120, 110, or even 100° C. and preferably using infrared heating,
d. and curing at Tour for a curing time preferably less than 40, 30, 20, 15, 10 or even 5 minutes.

The powder coating composition at the Tour preferably has a melt viscosity at the curing temperature less than 60 Pas, more preferably less than 40, 30, 20, 10 or even 5 Pas. The melt viscosity is to be measured at the very onset of the reaction or without C2 of the catalysis system.

In a preferred embodiment of the method the curing temperature is between 75 and 140° C., preferably between 80 and 120° C. and the catalyst system C is a latent catalyst system as described above which allows for powder coating a temperature sensitive substrate, preferably MDF, wood, plastic, composite or temperature sensitive metal substrates like alloys.

Therefore, the invention also relates to articles coated with a powder coating composition of the invention, preferably having a temperature sensitive substrate like MDF, wood, plastic or metal alloys and wherein preferably the crosslinking density XLD of the coating is at least 0.01, preferably at least 0.02, 0.04, 0.07 or even 0.1 mmole/cc (as determined by DMTA) and is preferably lower than 3, 2, 1.5, 1 or even 0.7 mmole/cc.

The powder coating composition, may further comprise additives such as additives selected from the group of pigments, dyes, dispersants, degassing aids, levelling additives, matting additives, flame retarding additives, additives for improving film forming properties, for optical appearance of the coating, for improving mechanical properties, adhesion or for stability properties like colour and UV stability. These additives can be melt-mixed together with one or more of the components of the powder coating composition.

Powder paints can also be designed to produce matte coatings, using similar avenues as in conventional powder coatings systems, either relying on additives or through intentional inhomogeneous crosslinking using either powder blend systems or systems based on blends of polymers of different reactivity.

Standard powder coating processing can be used, typically involving solidifying the extrudate immediately after it leaves the extruder by force-spreading the extrudate onto a cooling band. The extruded paint can take the form of a solidified sheet as it travels along the cooling band. At the end of the band, the sheet is then broken up into small pieces, preferably via a peg breaker, to a granulate. At this point, there is no significant shape control applied to the granules, although a statistical maximum size is preferred. The paint granulate is then transferred to a classifying microniser, where the paint is milled to very precise particle size distribution. This product is then the finished powder coating paint.

The invention will be illustrated by the following non limiting examples.

### EXAMPLES

### OH Value

The OHV was determined by manual titration of the prepared blanks and sample flasks. The indicator solution is made up by dissolving 0.80 g of Thymol Blue and 0.25 g of Cresol Red in 1 L of methanol. 10 drops of indicator solution is added to the flask which is then titrated with the standardized 0.5N methanolic potassium hydroxide solution. The end point is reached when the color changes from yellow to grey to blue and gives a blue coloration which is maintained for 10 seconds. The hydroxy value is then calculated according to:

$$Hydroxy Value = ( B - S ) \times N \times 56.$$

$$1 / M + AV$$

Where:
B=ml of KOH used for blank titration
S=ml of KOH used for sample titration
N=normality of potassium hydroxide solution
M=sample weight (base resin)
AV=Acid Value of the base resin

The Net Hydroxy Value is defined as: Net OHV=(B−S)×N×56. 1/M

### Amine Value

A freshly prepared solvent blend of 3:1 xylene:ethanol propanol is prepared. A quantity of resin is accurately weighed out into a 250 ml conical flask. 50-60 ml of 3:1 xylene:ethanol is then added. The solution is heated gently until the resin is entirely dissolved, and ensuring the solution does not boil. The solution is then cooled to room temperature and a potentiometric titration was conducted with 0.1 M hydrochloride acid until after the equivalence point.

### GPC Molecular Weight

Molar mass distribution of polymers was determined with Gel Permeation Chromatography (GPC) on Perkin-Elmer HPLC series 200 equipment, using refractive index (RI) detector and PLgel column, using as eluens THF, using calibration by polystyrene standards. Experimental molecular weights are expressed as polystyrene equivalents.

### DSC Tg

Resin and paint glass transition temperatures reported herein are the mid-point Tg's determined from Differential Scanning calorimetry (DSC) using a heating rate of 10° C./min.

### Impact Resistance

The Impact test was carried out in accordance with ASTM D 2794 on the powder coatings panels on both the coating and the reverse side. The highest impact which does not crack the coating is recorded in inch. Pounds (in·lb).

### Solvent Resistance

The solvent resistance of the cured film is measured by double rubs using a small cotton ball saturated with methyl ethyl ketone (MEK). It is judged by using a rating system (0-5, best to worst) as described below.
0. no perceptible change. Cannot be scratched with a finger-nail
1. slight loss of gloss
2. Some loss of gloss
3. the coating is very dull and can be scratched with a finger-nail
4. the coating is very dull and quite soft
5. the coating is cracked

### Abbreviations

TABLE 1
description of the abbreviations used in the examples.

| NPG | neopentyl glycol | |
|---|---|---|
| IPA | isophthalic acid | |
| TPA | terephthalic acid | |
| DEG | diethylene glycol | |
| IPDI | isophorone diisocyanate | |
| HDI | hexamethylene diisocyanate | |
| DBTL | dibutyltin dilaurate | |
| TEAHCO₃ | tetraethylammonium bicarbonate | |
| TEAOH | tetraethylammonium hydroxide | |
| Methyl ethyl ketone | MEK | |
| AV | acid value | |
| OHV | hydroxyl value | |
| Wt % | weight percent | |
| Mn | number average molecular weight | |
| Mw | weight average molecular weight | |
| Tg | glass transition Temperature | |
| EQW | equivalent weight | |
| Araldite ® PT912 | glycidyl ester resin (ex Huntsman) | epoxy EQW is 154 g/mol |
| Araldite ® GT7004 | bisphenol-A epoxy resin (ex Huntsman) | epoxy EQW is 752 g/mol |
| MODAFLOW ® P6000 | powder coating flow modifiers on silica | |
| | carrier (ex Allnex) | |
| Ken-React ® KR46B | titanium (IV) tetrakis octanolato | |
| | adduct 2 moles (di-tridecyl)hydrogen | |
| | phosphite (Kenrich petrochemicals, Inc) | |

### Preparation of Amorphous Materials

### Preparation of Malonate Donor Resin M-1

A 5 liter round bottom reactor equipped with a 4 necked lid, metal anchor stirrer, Pt-100, packed column with top thermometer, condenser, distillate collection vessel, thermocouple and a N2 inlet was charged with 1300 g isosorbide (80%), 950 g NPG and 1983 g TPA. The temperature of the reactor was gently raised to about 100° C., and 4.5 g of Ken-React® KR46B catalyst was added. The reaction temperature was further increased gradually to 230° C., and the polymerization was progressed under nitrogen with continuous stirring until the reaction mixture is clear and the acid value is below 2 mg KOH/g. During the last part of the reaction, vacuum was applied to push the reaction to completion. The temperature was lowered to 120° C., and 660 g of diethylmalonate was added. The temperature of the reactor was then increased to 190° C. and maintained until no more ethanol was formed. Again, vacuum was applied to push the reaction to completion. After the transesterification was completed, the hydroxyl value of the polyester was measured. The final OHV was 27 mg KOH/g, with a GPC Mn of 1763 and a Mw of 5038, and a Tg (DSC) of 63° C.

### Preparation of Urethane Acrylate Acceptor Resin UA-1

A urethane-acrylate based on IPDI, hydroxy-propyl-acrylate, glycerol is prepared with the addition of suitable polymerization inhibitors, as described in e.g EP0585742. In a 5 liter reactor equipped with thermometer, stirrer, dosing funnel and gas bubbling inlet, 1020 parts of IPDI, 1.30 parts DBTL and 4.00 parts of hydroquinone are loaded. Then 585 parts of hydroxy propylacrylate are dosed, avoiding that temperature increases to more than 50° C. Once addition is completed, 154 parts of glycerine are added. 15 minutes after the exothermic reaction subsides, the reaction product is cast on a metallic tray. The resulting urethane-acrylate is characterized by a GPC Mn of 744 and Mw of 1467, Tg (DSC) of 51° C., residual isocyanate content <0.1%, and theoretical unsaturation EQW of 392 g/mol.

### Preparation of Carboxylate Terminated Retarder Resin T-1

A 5 liter round bottom reactor equipped with a 4 necked lid, metal anchor stirrer, Pt-100, packed column with top thermometer, condenser, distillate collection vessel, thermocouple and a N2 inlet was charged with 1180 g NPG and 2000 g IPA. The temperature of the reactor was increased to 230° C., and the polymerization was progressed under nitrogen with continuous stirring until the reaction mixture is clear. The final product obtained has AV of 48 mg KOH/g and Tg (DSC) of 55° C.

### Preparation of Catalyst Precursor P-1

To prepare the catalyst precursor, a carboxylate terminated polyester resin (AV of 48) was melted and mixed with an aqueous solution of tetraethylammonium bicarbonate TEAHCO₃ (41%) using a Leistritz ZSE 18 twin-screw extruder. The extruder comprised a barrel housing nine consecutive heating zones, that were set to maintain the following temperature profile 30-50-80-120-120-120-120-100-100 (in ° C.) from inlet to outlet. The solid polyester resin was added through first zone at a rate 2 kg/h, and liquid TEAHCO₃ was injected through second zone at 0.60 kg/h. Mixing was taken place between zone 4 to 7 and the screw was set to rotate at 200 rpm. Volatiles and water generated from acid-base neutralization was removed with assistance of vacuum at zone 7. The extruded strand was immediately cooled and collected after leaving the die. The final product obtained has AV of 11 mg KOH/g, amine value of 33 KOH/g and Tg (DSC) of 48° C.

### Preparation of (Semi) Crystalline Materials

### Preparation of (Semi) Crystalline Urethane Acrylate Resin CUA-1

504.6 g HDI, 1 g DBTL and 5 g butylated hydroxytoluene (BHT) were charged into a 2 liter round bottom reactor and heated to 50° C. under dry air. A mixture of 288.3 g hydroxybutyl acylate and 212.2 g DEG was then added drop-wisely into the reactor to start the reaction, and the process temperature was kept below 120° C. The (semi) crystalline urethane-acrylate product obtained has a max and an end DSC melting temperature of 106° C. and 113° C. respectively. The theoretical unsaturation EQW=506 g/mol.

### Preparation of (Semi) Crystalline Acid Retarder and Corresponding Catalyst Precursor According to the Invention

### CT-1 & CP-1

379.3 g DEG and 1 g DBTL was charged into a 2 liter round bottom reactor, and heated to 50° C. 497.9 HDI was then added drop-wisely into the reactor to start the reaction under nitrogen protection, and the process temperature was kept below 120° C. After that, 122.8 g succinic anhydride was charged into the reactor. The reaction is proceeded at 120° C. until the desire acid value was achieved. The final product obtained CT-1 has AV of 69 mg KOH/g, Tg (DSC) of −5° C., a max and an end DSC melting temperature of 115° C. and 125° C. respectively.

To prepare the corresponding catalyst precursor CP-1, 1790 g of CR-1 was charged into a rector and melted by heating up to 125° C. 842.5 g tetraethylammonium hydroxide (TEAOH) aqueous solution (35%) was then slowly added into the reactor, and mixed with the melted crystalline acid resin with continue stirring. Volatiles and water generated from acid-base neutralization was removed with assistance of vacuum. The final product obtained CP-1 has AV of 36 mg KOH/g, amine value of 44 mg KOH/g, Tg (DSC) of −5° C., a max and an end DSC melting temperature of 110° C. and 120° C. respectively.

### CT-2 & CP-2

324.3 g DEG and 1 g DBTL was charged into a 2 liter round bottom reactor, and heated to 50° C. 401.2 hexamethylene diisocyanate (HDI) was then added drop-wisely into the reactor to start the reaction under nitrogen protection, and the process temperature was kept below 120° C. After that, 136.8 g hydroxypivalic acid was charged into the reactor and the reaction is proceeded at 120° C. until achieving full homogenization. Finally, another portion of 166.3 g of HDI was charged slowly into the reactor over a period of 30 mins. The final product obtained CT-2 has AV of 64 mg KOH/g, Tg (DSC) of 10° C., a max and an end DSC melting temperature of 120° C. and 128° C. respectively.

To prepare the corresponding catalyst precursor CP-2, 700 g of CR-1 was charged into a rector and melted by heating to 125° C. 169.7 g tetraethylammonium hydroxide (TEAOH) aqueous solution (35%) was then slowly added into the reactor, and mixed with the melted crystalline acid resin with continue stirring. Volatiles and water generated from acid-base neutralization was removed with assistance of vacuum. The final product obtained CP-2 has AV of 23 mg KOH/g, amine value of 29 mg KOH/g, Tg (DSC) of 10° C., a max and an end DSC melting temperature of 121° C. and 128° C. respectively.

### CT-3

41.68 g hydroxypavilic acid and 100.5 g 3-methyl-1,5-pentanediol were charged into a 2 liter round bottom reactor. The mixture was mixed and heated to 60° C. 172.8 g HDI was then added drop-wisely into the reactor to start the reaction under nitrogen protection. The reaction was proceed at around 110° C. until all isocyanate groups have been reacted. The final product obtained CT-3 has AV of 63 mg KOH/g, Tg (DSC) of 9° C., a max and an end DSC melting temperature of 88° C. and 99° C. respectively.

### CT-4

324.3 g DEG, 136.8 g hydroxypivalic acid and 1 g DBTL was charged into a 2 liter round bottom reactor, and heated to 50° C. 401.2 hexamethylene diisocyanate (HDI) was then added drop-wisely into the reactor to start the reaction under nitrogen protection, and the process temperature was kept below 120° C. until all isocyanate groups have been reacted. The final product obtained CT-4 has a theoretical AV of 64 mg, a max and an end DSC melting temperature of 116° C. and 122° C. respectively.

### CP-5

The (semi) crystalline catalyst precursor CP-5 was prepared by a two-steps route. In the first step, 0.029 g DBTL, 32.3 g of ethyl lactate, and 75.5 g of DEG were charged into a reaction vessel. The reaction mixture was brought to 60° C., when feeding of HDI was initiated. A total amount of 142.2 g of HDI was fed drop wisely, allowing the temperature to slowly increase to 110° C., over the course of one hour. Towards the end of the reaction, when some crystallization became visible, extra heat was applied to raise the temperature to 120° C. The reaction was then proceeded at 120° C. for 20 minutes after completing the addition of HDI. Theoretical Mn of this product is expected to be 1800, with a ester EQW of 900 g/mol. DSC analysis indicated a max and an end melting temperature of 133° C. and 140° C., respectively. In the second step, 127.9 g of the obtained product from first step was charged into a reactor equipped with stirrer, thermometer, dropping funnel and distillation set-up. The crystalline polyurethane was carefully melted, to a temperature of 135° C. 44 g tetraethylammonium hydroxide (TEAOH) aqueous solution (35%) was then slowly added into the reactor, and mixed with the melted crystalline acid resin with continue stirring. Volatiles (water and ethanol) were removed assisted with some N2-stream over the reaction mass. The feeding and distillation step took about 1 hour, during which temperatures were maintained between 125 and 135° C. The final product obtained CP-5 has an amine value of 24 mg KOH/g, a max and an end DSC melting temperature of 109° C. and 123° C., respectively.

### CP-6

A reaction vessel was filled with a mixture of 6 mg DBTL, 14.3 g of DEG and 6.87 g of dimethylethanolamine, and heated to 60° C. At this point, a start was made with feeding HDI (total amount 29.1 g). The reaction mass was allowed to slowly rise in temperature over the course of the feeding over 50 minutes up to 105° C. At the end of the feeding process, when crystallization phenomena became visible, extra heat was applied to raise the temperature to 120° C. Heating was continued for another 20 minutes after feeding was complete. The final product obtained CP-6 has a theoretical expected Mn of 1300, amine EQW of 650 g/mol, a max and an end DSC melting temperature of 110° C. and 117° C. respectively.

### Powder Coating Compositions Preparations

To prepare the powder coating compositions, the raw materials were first premixed in a high speed Thermoprism Pilot Mixer 3 premixer at 1500 rpm for 20 seconds before being extruded in a Baker Perkins (formerly APV) MP19 25: 1 L D twin screw extruder. The extruder speed was 250 rpm and the four extruder barrel zone temperatures were set at 15, 25, 100 and 100° C. for extruding amorphous resins, or 15, 25, 120 and 100° C. for extruding (semi) crystalline resins. Following extrusion, the extrudates were grounded using a Retsch GRINDOMIX GM 200 knife mill. The grounded extrudates were sieved to below 100 μm using Russel Finex 100-micron mesh Demi Finex laboratory vibrating sieves.

### Results

PW1 (comparative) and PW2-PW5 (Inventive) are examples of powder coatings that were formulated in the stoichiometry to have a reactive acryloyl/C—H2 ratio of 1.5:1, 50 meq of catalyst precursor, 50 meq of acid retarder and 200 meq activator, as listed in Table 2. All paints were sprayed onto aluminum and steel panels with a film thickness between 80-100 μm, and cured for 22 minutes at 120° C. The analysis and application results of the paints are summarized in Table 3.

TABLE 2
Powder coating composition PW1-PW5.

| | Powder coating compositions | | | | |
|---|---|---|---|---|---|
| | (values in parts by weight) | | | | |
| | PW1 | PW2 | PW3 | PW4 | PW5 |
| Malonate donor M-1 | 301 | 323 | 344 | 334 | 318 |
| Urethane-acrylate acceptor UA-1 | 178 | 191 | 204 | 198 | 94 |
| Crystalline urethan-acrylate | | | | | 121 |
| acceptor CUA-1 | | | | | |
| Catalyst precursor P-1 | 59 | | | | |
| Crystalline catalyst | | 44 | 45 | | |
| precursor CP-1 | | | | | |
| Crystalline catalyst | | | | 65.5 | 65.5 |
| precursor CP-2 | | | | | |
| Retarder resin T-1 | 46 | 27 | | | |
| Crystalline retarder resin CT-1 | | | 5 | | |
| Araldite ® GT 7004 | 116 | 115 | 103 | 103 | 103 |
| Titanium dioxide Kronos 2160 | 290 | 290 | 290 | 290 | 290 |
| Modaflow P6000 | 10 | 10 | 10 | 10 | 10 |
| Total | 1000 | 1000 | 1000 | 1000 | 1000 |

PW1 is a comparative reference paint prepared with only amorphous components. The paint has a Tg of 56° C. and can be well cured after 22 mins at 120° C., as evidenced by good solvent resistance. However, it has no adhesion and impact resistance at all on both aluminum and steel substrates.

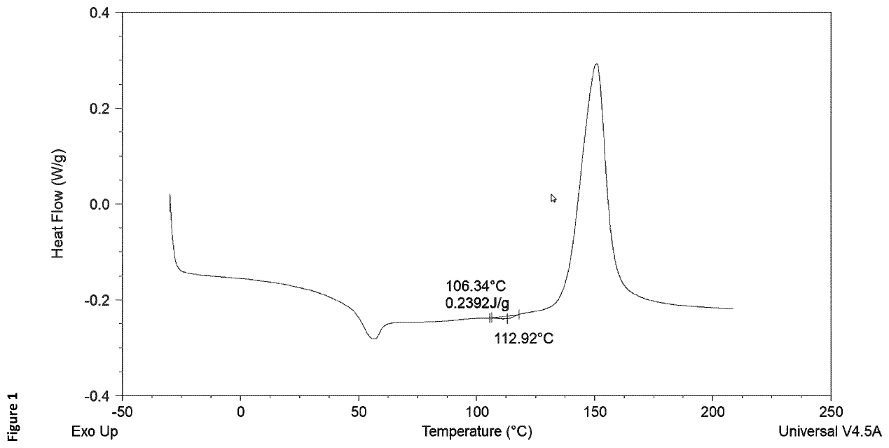

PW2 was prepared by replacing the amorphous catalyst precursor P-1 with a (semi) crystalline one CP-1. The impact of (semi) crystalline material on the paint Tg is neglectable, and a reduction of paint Tg for 1° C. was determined by DSC analysis. This is a strong evidence that most (semi) crystalline catalyst precursors have recrystallized in the paint after extrusion. A DSC scan (FIG. 1) of PW2 paint shows a melting peak at the same melting range as CP-1 (delta H due to melting=0.24 J/g). This also suggests that most (semi) crystalline catalyst precursors are in the form of crystals within the amorphous matrix of the paint. Curing speed is comparable to the amorphous catalyst, as good solvent resistance can be achieved. (semi) Crystalline precursor CP-1 significantly improved the adhesion of coating on metal substrates and obtained perfect adhesion. In addition, mechanical property of the film has slightly improved in terms of impact resistance. This is probably because CP-1 has plasticize the cured film, as

TABLE 3
Summary of application and DSC analysis
results of powder paints PW1-PW5.

| | | | | | DSC | Delta H |
|---|---|---|---|---|---|---|
| | Impact | | | DSC | cured | due to |
| Paint | Resistance | | Solvent | Paint Tg | film Tg | melting |
| No. | (in · lb) | Adhesion | Resistance | (° C.) | (° C.) | (J/g) |
| PW1 | 0 | GT5 | 1 | 56 | 92 | n/a |
| PW2 | 10 | GT0 | 0-1 | 55 | 90 | 0.24 |
| PW3 | 10 | GT0 | 0-1 | 52 | 87 | 0.31 |
| PW4 | 10 | GT0 | 0-1 | 50 | 91 | 0.46 |
| PW5 | 20 | GT0 | 0-1 | 50 | 78 | 2.65 |

evidence of reduction in cured film Tg for 2° C.

PW3 was formulated with both (semi) crystalline acid retarder CT-1 and precursor CP-1. The paint still has relatively high Tg, as most (semi) crystalline components believed to have been recrystallized in the paint after extrusion. This is evidenced by increasing in delta H to 0.31 J/g. The application results indicates good solvent resistance. Compare to PW1, adhesion and impact resistance have also been improved.

PW4 was prepared with an alternative (semi) crystalline catalyst precursor CP-2. CP-2 has the same backbone as CP-1, but the terminated carboxylates was prepared by reacting hydroxyl acids with isocyanate groups. The paint has slightly lower Tg due to higher amount of (semi) crystalline in the formulation. It is still believed most CP-2 has been recrystallized in the paint after extrusion, and delta H increased to 0.46 J/g. Compare to full amorphous formulation PW1, application results also showed advantage over adhesion and impact resistance.

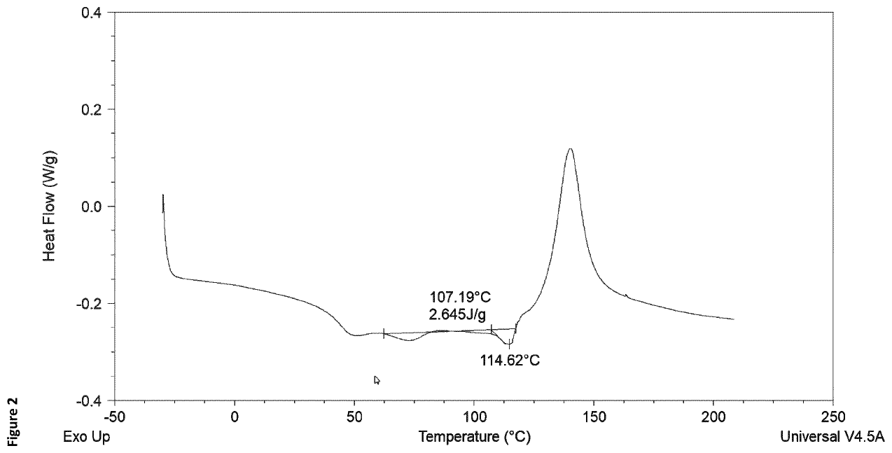

PW5 was prepared with a (semi) crystalline urethane acrylate acceptor CUA-1 and CP-2. Compare to PW4, the paint Tg has not been reduced with further addition of (semi) crystalline acceptor. It is believed that CUA-1 and CP-2 can recrystallize together in the paint, since they have similar backbone structure. A DSC scan of PW5 (FIG. 2) has clearly demonstrated the presence of crystals in amorphous matrix of paint, and the melting peaks are in good agreement with the melting range of CUA-1 and CP-2.

1. A powder coating composition comprising a crosslinkable composition and a catalyst system, wherein the crosslinkable composition is formed by a crosslinkable donor component A and a crosslinkable acceptor component B that are crosslinkable by a Real Michael Addition (RMA) reaction via the catalyst system, and which catalyst system is able to catalyze the RMA crosslinking reaction at a curing temperature below 140° C., preferably below 120° C. or even more preferably below 110° C. or below 100° C. and preferably at least 70° C., preferably at least 80, 90 or 100° C.,
wherein the crosslinkable composition comprises
a) the crosslinkable donor component A having at least 2 acidic C—H donor groups in activated methylene or methine, and
b) the crosslinkable acceptor component B having at least 2 activated unsaturated acceptor groups C═C, which react with component A by Real Michael Addition (RMA) to form a crosslinked network,
and
wherein the catalyst system comprises a (semi) crystalline precursor P, an activator C and optionally a retarder T;
wherein the (semi) crystalline precursor P is a weak base with a pKa of its protonated form of more than 2, preferably more than 3, more preferably more than 4 and even more preferably at least 5 units lower than that of the activated C—H groups in donor component A; and the activator C can react with P at curing temperature, producing a strong base (CP) that can catalyze the Michael Addition reaction between A and B;
wherein the retarder T is preferably a (semi) crystalline retarder, wherein the retarder T is an acid that has a pKa of more than 2, more preferably more than 3, even more preferably more than 4 or 5 points lower than that of the activated C—H in A, and which upon deprotonation produces a weak base that can react with the activator C, producing a strong base that can catalyse the Michael Addition reaction between the crosslinkable compositions A and B.

2. The powder coating composition according to claim 1, wherein the (semi) crystalline precursor and/or (semi) crystalline retarder is partially in a crystalline state and has a melting temperature below 140, 130° C., preferably below 120° C., 110° or even below 100° C. and which precursor and/or retarder comprises a urethane backbone.

3. The powder coating composition according to claim 1, wherein the (semi) crystalline precursor P and/or (semi) crystalline retarder T has a urethane backbone prepared by reacting a hexamethylene diisocyanate (HDI) with at least a compound (i) comprising at least two, preferably two, isocyanate reactive groups, preferably hydroxyl, and is more preferably a diol.

4. The powder coating composition according to claim 1, wherein the (semi) crystalline retarder T and/or precursor P comprise a urethane backbone and is prepared by
(ia) reacting HDI with a compound (i) which is a diol and a compound (ii) comprising a hydroxyl and a carboxylic acid functional group to obtain a carboxylic acid based (semi) crystalline retarder T;
(ib) neutralizing the carboxylic acid based (semi) crystalline retarder T to obtain a (semi) crystalline precursor P; or
(iia) reacting HDI with a stoichiometric excess of compound (i) which is a diol to obtain a hydroxyl terminated urethane intermediate;
(iib) reacting the hydroxyl urethane intermediate with a cyclic anhydride to obtain a carboxylic acid based (semi) crystalline retarder T;
(iic) neutralizing the carboxylic acid based (semi) crystalline retarder T to obtain a (semi) crystalline precursor P; or
(iiia) reacting HDI with a compound (i) which is a diol and a compound (iii) having a hydroxyl and carboxylate ester functional group to obtain a (semi) crystalline urethane ester;
(iiib) hydrolysing the ester groups of the (semi) crystalline urethane ester with a hydroxide to obtain a (semi) crystalline precursor P;
(iiic) optionally acidifying the (semi) crystalline precursor of (iiib) to obtain a crystalline retarder T;
(iva) reacting HDI with compound (i) which is a diol and a compound (iv) comprising a hydroxyl and a tertiary amine functional group to obtain a tertiary amine based (semi) crystalline precursor P;
(ivb) protonating the tertiary-amine based (semi) crystalline precursor P to obtain a (semi) crystalline retarder T; or
(va) reacting HDI with compound (i) which is a diol and a compound (v) comprising a hydroxyl and an acrylate functional group to obtain an acrylate functional (semi) crystalline intermediate;
(vb) reacting the acrylate groups of the acrylate functional (semi) crystalline intermediate with a secondary amine to obtain a tertiary amine functional semi-crystalline precursor P;
(vc) protonating the tertiary-amine based (semi) crystalline precursor P to obtain a (semi) crystalline retarder T.

5. The powder coating composition according to claim 1, wherein the (semi) crystalline precursor P is prepared by
(ia) reacting HDI with a compound (i) which is a diol and a compound (ii) comprising a hydroxyl and a carboxylic acid functional group to obtain a carboxylic acid based (semi) crystalline retarder T;
(ib) neutralizing the carboxylic acid based (semi) crystalline retarder T to obtain a (semi) crystalline precursor P; or
(iia) reacting HDI with a stoichiometric excess of compound (i) which is a diol to obtain a hydroxyl terminated urethane intermediate;
(iib) reacting the hydroxyl urethane intermediate with a cyclic anhydride to obtain a carboxylic acid based (semi) crystalline retarder T;
(iic) neutralizing the carboxylic acid based (semi) crystalline retarder T to obtain a (semi) crystalline precursor P; or
(iiia) reacting HDI with a compound (i) which is a diol and a compound (iii) having a hydroxyl and carboxylate ester functional group to obtain a (semi) crystalline urethane ester:
(iiib) hydrolysing the ester groups of the (semi) crystalline urethane ester with a hydroxide to obtain a (semi) crystalline precursor P;
(iiic) optionally acidifying the (semi) crystalline precursor of (iiib) to obtain a crystalline retarder T;
(iva) reacting HDI with compound (i) which is a diol and a compound (iv) comprising a hydroxyl and a tertiary amine functional group to obtain a tertiary amine based (semi) crystalline precursor P;
(ivb) protonating the tertiary-amine based (semi) crystalline precursor P to obtain a (semi) crystalline retarder T; or
(va) reacting HDI with compound (i) which is a diol and a compound (v) comprising a hydroxyl and an acrylate functional group to obtain an acrylate functional (semi) crystalline intermediate;
(vb) reacting the acrylate groups of the acrylate functional (semi) crystalline intermediate with a secondary amine to obtain a tertiary amine functional semi-crystalline precursor P;
(vc) protonating the tertiary-amine based (semi) crystalline precursor P to obtain a (semi) crystalline retarder T,
wherein the hydrolysis and/or neutralization is done with
a hydroxide salt of a cation that is not acidic, preferably a cation according to formula Y(R′)4, wherein Y represents N or P, and wherein each R′ can be as same or different alkyl, aryl or aralkyl possible linked to a polymer, preferably a quaternary ammonium or phosphonium cation, preferably a tetra-butyl ammonium cation or a tetra-ethyl ammonium cation; or
a very strong basic amine, preferably selected from the group of amidines; preferably 1,8-diazabicyclo (5.4.0)undec-7-ene (DBU), or guanidines; preferably 1,1,3,3-tetramethylguanidine (TMG), optionally in the presence of some water.

6. The powder coating composition according to claim 1 wherein the diol (i) has:
a connecting chain between the hydroxyl groups that contain ether- or thioether groups, preferably —CH2-O—CH2-, —CH2-S—CH2-, —CH2-S—S—CH2- and the connection chain has a maximum length of 11 carbon atoms and/or heteroatoms between the hydroxyl groups; or
a connecting chain between the hydroxyl groups containing a —CH(CH3)- unit or a —CH(CH2CH3)- preferably in a central position, whereby the connecting chain has a chain length that has an uneven number of carbon atoms and/or heteroatoms of less than 6 between the hydroxyl groups;
wherein the hydroxyl groups are primary hydroxyl groups and wherein the diols are not aromatic and not cycloaliphatic.

7. The powder coating composition according to claim 3, wherein compound (i) comprising at least two isocyanate reactive groups is a diol selected from the group consisting of diethylene glycol; triethylene glycol; 3-methyl 1,5-pentanediol, 2-methyl 1,3-propane diol; 2,2′-thio diethanol; 2,2′-dithio diethanol; tetraethylene glycol; di 1,3-propanediol); di(1,4-butanediol).

8. The powder coating composition according to claim 3, wherein the ratio of the isocyanate reactive groups of compound (i) and where present compound (ii), (iii), (iv) or (v) relative to the isocyanate groups is preferably above one, more preferably the molar ratio of the isocyanate reactive groups over isocyanate groups is between 1.0 to 1.5, more preferably from 1.01 to 1.2.

9. The powder coating composition according to claim 1, wherein the number average molecular weight of the (semi) crystalline retarder is between 300 and 4000, preferably between 500 and 3000, more preferably between 1000 and 2000 g/mol.

10. The powder coating composition according to claim 1, wherein the catalyst system is a separated catalyst system wherein the (semi) crystalline precursor P and activator C are macrophysically separated.

11. The powder coating composition according to claim 1, wherein
the activator C is selected from the group consisting of epoxide, carbodiimide, oxetane, oxazoline or aziridine functional components, preferably an epoxide or carbodiimide; and
the (semi) crystalline precursor P is a carboxylate or a tertiary amine; and
the retarder T is preferably a protonated precursor P.

12. The powder coating composition according to claim 1, comprising
an activator C in an amount between 1 and 600 μeq/gr, preferably between 10 and 400, more preferably between 20 and 200 μeq/gr relative to total weight of binder components A and B and catalyst system,
a (semi) crystalline precursor P in an amount between 1 and 300 μeq/gr, preferably between 10 and 200, more preferably between 20 and 100 μeq/gr relative to total weight of binder components A and B and catalyst system,
optionally a retarder T in an amount between 1 and 500, preferably between 10 and 400, more preferably between 20 and 300 μeq/gr and most preferably between 30 and 200 μeq/gr, relative to total weight of binder components A and B and catalyst system
preferably wherein the equivalent amount of C
(i) is higher than the amount of T, when present, preferably by an amount between 1 and 300 μeq/gr, preferably between 10 and 200, more preferably between 20 and 100 μeq/gr and
(ii) is preferably higher than the amount of P and
(iii) more preferably higher than the sum of the amount of P and T.

13. The powder coating composition according to claim 1,
a. wherein the (semi) crystalline precursor P respectively represents between 10 and 100 equivalent % of the sum of P and T,
b. preferably the amount of retarder T is 20-400 eq %, preferably 30-300 eq % of the amount of P,
c. wherein preferably the ratio of the equivalent amount of C to the sum of the amount of P and Tis at least 0.5, preferably at least 0.8, more preferably at least 1 and preferably at most 3, more preferably at most 2,
d. the ratio of C to T is preferably at least 1, preferably at least 1.5, most preferably at least 2.

14. The powder coating composition according to claim 1, wherein the crosslinkable donor component A and/or the acceptor component B are (semi) crystalline compounds, preferably having a urethane backbone, which urethane backbone is preferably prepared by reacting a hexamethylene diisocyanate with a compound comprising at least two isocyanate reactive groups, preferably an alcohol, and is more preferably a diol.

15. The powder coating composition according to claim 14, wherein the urethane backbone of the (semi) crystalline donor component A and/or the (semi) crystalline acceptor B and the (semi) crystalline precursor (P) have a urethane backbone prepared by reacting HDI with at least a compound (i) having at least two isocyanate reactive groups, which is the same for the (semi) crystalline precursor (P) and the (semi) crystalline donor component A and/or the (semi) crystalline acceptor B,
which compound (i) is preferably a diol which diol has:
a connecting chain between the hydroxyl groups that contain ether- or thioether groups, preferably —CH2-O—CH2-, —CH2-S—CH2-, —CH2-S—S—CH2- and the connection chain has a maximum length of 11 carbon atoms and/or heteroatoms between the hydroxyl groups; or
a connecting chain between the hydroxyl groups containing a —CH(CH3)- unit or a —CH(CH2CH3)- preferably in a central position, whereby the connecting chain has a chain length that has an uneven number of carbon atoms and/or heteroatoms of less than 6 between the hydroxyl groups;
wherein the hydroxyl groups are primary hydroxyl groups and wherein the diols are not aromatic and not cycloaliphatic.

16. The powder coating composition according to claim 1 wherein
a. crosslinkable component A comprises at least 2 acidic C—H donor groups in activated methylene or methine in a structure Z1(—C(—H)(—R)—)Z2 wherein R is hydrogen, a hydrocarbon, an oligomer or a polymer, and wherein Z1 and Z2 are the same or different electron-withdrawing groups, preferably chosen from keto, ester or cyano or aryl groups, and preferably comprises an activated C—H derivative having a structure according to formula 1: 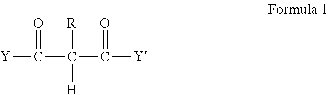
wherein R is hydrogen or an optionally substituted alkyl or aryl and Y and Y′ are identical or different substituent groups, preferably alkyl, aralkyl or aryl, or alkoxy or wherein in formula 1 the —C(═O)—Y and/or —C(═O)—Y′ is replaced by CN or aryl, no more than one aryl or wherein Y or Y′ can be NRR′ (R and R′ are H or optionally substituted alkyl) but preferably not both, wherein R, Y or Y′ optionally provide connection to an oligomer or polymer, said component A preferably being a malonate, acetoacetate, malonamide, acetoacetamide or cyanoacetate groups, preferably providing at least 50, preferably 60, 70 or even 80% of the total of C—H acidic groups in crosslinkable component A,
b. Component B comprises the at least 2 activated unsaturated RMA acceptor groups preferably originate from acryloyl, methacryloyl, itaconates, maleate or fumarate functional groups,
wherein preferably at least one, more preferably both, of components A or B is a polymer and
wherein preferably the composition comprises a total amount donor groups C—H and acceptor groups C═C per gram binder solids from 0.05 to 6 meq/gr binder solids and preferably the ratio of acceptor groups C═C to donor groups C—H is more than 0.1 and less than 10.

17. The powder coating composition according to claim 1, wherein at least one of crosslinkable components A or B or hybrid A/B is a polymer, preferably chosen from the group of acrylic, polyester, polyester amide, polyester-urethane polymers, which polymer
has a number average molecular weight Mn, as determined with GPC, of at least 450 gr/mole, preferably at least 1000, more preferably at least 1500 and most preferably at least 2000 gr/mole;
has a weight average molecular weight Mw, as determined with GPC, of at most 20000 gr/mole, preferably at most 15000, more preferably at most 10000 and most preferably at most 7500 gr/mole;
preferably has a polydispersity Mw/Mn below 4, more preferably below 3;
has an equivalent weight EQW in C—H or C═C of at least 150, 250, 350, 450 or 550 gr/mole and preferably at most 2500, 2000, 1500, 1250 or 1000 gr/mole and a number average functionality of reactive groups C—H or C═C between 1-25, more preferably 1.5-15 even more preferably 2-15, most preferably 2.5-10 C—H groups per molecule;
preferably has a melt viscosity at a temperature in the range between 100 and 140° C. less than 60 Pas, more preferably less than 40, 30, 20, 10 or even 5 Pas;
preferably comprises amide, urea or urethane bonds and/or comprises high Tg monomers, preferably cycloaliphatic or aromatic monomers, in particular polyester monomers chosen from the group of 1,4-dimethylol cyclohexane (CHDM), tricyclodecanedimethanol (TCD diol), isosorbide, penta-spiroglycol or hydrogenated bisphenol A and tetramethyl-cyclobutanediol; and/or
has a Tg above 25° C., preferably above 35° C., more preferably above 40, 50 or even 60° C. as the midpoint value determined by DSC at a heating rate of 10° C./min or is a (semi) crystalline polymer with a melting temperature between 40° C. and 150, preferably 130° C., preferably at least 50 or even 70° C. and preferably lower than 120° C. (as determined by DSC at a heating rate of 10° C./min).

18. The powder coating composition according to claim 1, wherein the acceptor component B is a polyester (meth-)acrylate, a polyester urethane (meth-)acrylate, an epoxy (meth-) acrylate or a urethane (meth-)acrylate, or is a polyester comprising fumarate, maleate or itaconate units, preferably fumarate or is a polyester end-capped with isocyanate or epoxy functional activated unsaturated group.

19. A (semi)crystalline catalyst retarder T or precursor P suitable for use in a catalyst system for crosslinking a crosslinkable composition via a Real Michael Addition (RMA) reaction to obtain a powder coating composition according to claim 1, wherein the catalyst retarder T and/or precursor P is prepared by:
(ia) reacting HDI with a compound (i) which is a diol and a compound (ii) comprising a hydroxyl carboxylic acid groups to obtain a carboxylic acid based (semi) crystalline retarder T;
(ib) neutralizing the carboxylic acid based (semi) crystalline retarder T to obtain a (semi) crystalline precursor P; or
(iia) reacting HDI with a compound (i) which is a diol to obtain a hydroxyl terminated urethane intermediate;
(iib) reacting the hydroxyl urethane intermediate with a cyclic anhydride to obtain a carboxylic acid based (semi) crystalline retarder T;
(iic) neutralizing the carboxylic acid based (semi) crystalline retarder T to obtain a (semi) crystalline precursor P; or
(iiia) reacting HDI with a compound (i) which is a diol and a compound (iii) having a hydroxyl carboxylate ester groups to obtain a (semi) crystalline urethane ester;
(iiib) hydrolysing the ester groups of the (semi) crystalline urethane ester with a hydroxide to obtain a (semi) crystalline precursor P;
(iiic) optionally acidifying the (semi) crystalline precursor of (iiib) to obtain a crystalline retarder T
(iva) reacting HDI with a diol component (i) and a compound (iv) comprising a hydroxyl and a tertiary amine functional group to obtain a tertiary amine based (semi) crystalline precursor P;
(ivb) protonating the tertiary-amine based (semi) crystalline precursor P to obtain a (semi) crystalline retarder T; or
(va) reacting HDI with a diol component (i) and a compound (v) comprising a hydroxyl and an acrylate functional group to obtain an acrylate functional (semi) crystalline intermediate;
(vb) reacting the acrylate groups of the acrylate functional (semi) crystalline intermediate with a secondary amine to obtain a tertiary amine functional semi-crystalline precursor P;
(vc) protonating the tertiary-amine based (semi) crystalline precursor P to obtain a (semi) crystalline retarder T.

20. A (semi)crystalline catalyst retarder T or precursor P according to claim 19, wherein the (semi) crystalline precursor and/or (semi) crystalline retarder have a melting temperature of the compound itself that is below 145° C., 130° C., preferably below 120° C., 110° or even below 100° C. such as between 80 and 130° C., preferably between 80 and 120° C.

21. A (semi)crystalline catalyst retarder T or (semi)crystalline precursor P according to claim 19,
wherein the (semi) crystalline precursor P is a weak base with a pKa of its protonated form of more than 2, preferably more than 3, more preferably more than 4 and even more preferably at least 5 units lower than that of the activated C—H groups in donor component A; and the activator C can react with P at curing temperature, producing a strong base (CP) that can catalyze the Michael Addition reaction between A and B:
wherein the catalyst retarder T is preferably a (semi) crystalline retarder, wherein the retarder T is an acid that has a pKa of more than 2, more preferably more than 3, even more preferably more than 4 or 5 points lower than that of the activated C—H in A, and which upon deprotonation produces a weak base that can react with the activator C, producing a strong base that can catalyse the Michael Addition reaction between the crosslinkable compositions A and B.

22. A method for powder-coating a substrate comprising
a. applying a layer comprising the powder coating composition according to claim 1, to a substrate surface wherein the substrate preferably is a temperature sensitive substrate, preferably MDF, wood, plastic, composite or temperature sensitive metal substrates like alloys and
b. heating to a curing temperature Tcur between 75 and 140° C., and more preferably between 80 and 130, 120, 110, or even 100° C., preferably using infrared heating, wherein the melt viscosity at the curing temperature Tour is preferably less than 60 Pas, more preferably less than 40, 30, 20, 10 or even 5 Pas;
c. and curing at Tour for a curing time preferably less than 40, 30, 20, 15, 10 or even 5 minutes.

23. Articles coated with a powder having a the powder coating composition according to claim 1, wherein the articles preferably have a temperature sensitive substrate preferably selected from the group of MDF, wood, plastic, composite or metal alloys and wherein preferably the crosslinking density XLD is at least 0.01, preferably at least 0.02, 0.04, 0.07 or even 0.1 mmole/ml (as determined by DMTA) and is preferably lower than 3, 2, 1.5, 1 or even 0.7 mmole/ml.
